(19) United States
(12) Patent Application Publication
(10) Pub. No.: US 2026/0211653 A1
(43) Pub. Date: Jul. 23, 2026

(54) METHOD AND SYSTEM FOR DISTRIBUTING SOFTWARE COMPONENTS TO VEHICLES

(71) Applicant: MERCEDES-BENZ GROUP AG, Stuttgart (DE)

(72) Inventors: Johannes SCHÜTZNER, Böblingen (DE); Frank MÜLLER, Karlsruhe (DE); Matthias NISCH, Rottenburg (DE); Fabrice BECKER, Stuttgart (DE); Moritz FISCHER, Lichtenstein (DE)

(21) Appl. No.: 19/140,701

(22) PCT Filed: Dec. 5, 2023
(86) PCT No.: PCT/EP2023/084317

§ 371 Date: Jun. 18, 2025

(30) Foreign Application Priority Data
Dec. 20, 2022 (DE) 10 2022 004 825.6

(51) Int. Cl. G06F 8/61; G06F 8/71

(52) U.S. Cl. CPC G06F 8/61; G06F 8/71

(57) ABSTRACT

A software component is distributed to a vehicle of a fleet having a common equipment feature. A fleet type, minimum quality status, or intended purpose is assigned to the fleet. A software package is formed that includes at least one software component in a version permanently assigned to the software package. The software package is assigned a quality status depending on the result of quality assurance measures carried out on it. The software package is assigned to the fleet based on the common equipment feature of both the fleet and the software package, the quality status of the software package, and based on the fleet type, minimum quality status, or intended purpose of the fleet.

### BACKGROUND AND SUMMARY OF THE INVENTION

Exemplary embodiments of the invention relate to a method and a system for distributing at least one software component to a vehicle.

WO 2022/162815 A1 describes a software updating device comprising a controller and a storage device that updates software for a vehicle based on update data. The storage device stores a general package comprising at least the update data and identification packages. Each identification package comprises package identification information related to the general package and vehicle identification information associated with the package identification information that identifies a vehicle. The controller transmits, to a target vehicle on which software is to be updated, an identification package comprising the vehicle identification information associated with the target vehicle. At the request of the target vehicle, the controller transmits to it the general package to which the package identification information contained in the identification package relates.

US 2016/0170775 A1 describes a method in which a vehicle receives a software update intended for a control unit of the vehicle. Compatibility with the vehicle's control units is determined using tokens that specify the respective software versions of the control units. The software update is activated when a permissible configuration of software versions has been determined. A control unit of a vehicle can receive tokens from another control unit of the vehicle that indicate their respective software versions. The tokens are used to determine whether the control unit is the one with the latest software version. If this is the case, the compatibility of the versions is determined. Otherwise, the compatibility result determined by the control unit with the latest software version is used.

US 2019/0139332 A1 describes a method for evaluating the compatibility of a first system component of a vehicle. The method comprises the following steps: providing a database comprising vehicle platform configuration information with configuration information of two or more vehicle models, wherein each vehicle model comprises at least one view, wherein each view comprises at least one system component, wherein each system component comprises configuration information, and wherein at least two system components of two different vehicle models belong to the same view. Further, the method comprises determining compatibility between the first system component and at least one further system component of said vehicle platform by comparing respective configuration information and returning a compatibility result based on whether the first system component has been determined to be compatible with the at least one further system component.

Exemplary embodiments of the invention are directed to an improved method for distributing at least one software component to a vehicle, as well as to an improved system for distributing at least one software component to a vehicle.

In a method for distributing at least one software component to at least one vehicle, according to a first aspect of the invention, at least one group of vehicles, hereinafter referred to as a fleet, is formed from a totality of vehicles having at least one common equipment feature relevant with respect to software components. Such equipment features relevant to software components (hereinafter also referred to as software-relevant equipment features) can, for example, be properties of one or more control units installed in the vehicles, for example a hardware platform, an operating system, or a plurality of software components installed thereon, for example drivers or off-the-shelf software.

In other words: according to the invention, fleets are selected in such a way that vehicles in a first fleet are identical with regard to these software-relevant equipment features and there is at least one further fleet to which other vehicles are assigned, but which have the same software-relevant equipment features as each other and as the first fleet.

Each fleet is assigned at least one fleet type and/or a minimum quality status and/or an intended use. Optionally, further attributes can be assigned to a fleet.

By way of example, a fleet type can characterize a fleet as being intended for test purposes. Alternatively, a fleet type can characterize a productively manufactured or deployed fleet comprising vehicles used by a customer or potentially be sold to customers. A fleet type can also identify a fleet intended for special purposes, which comprises, for example, vehicles intended for specific marketing events.

Based on the intended purpose, a fleet can, for example, be labelled for use by the customer or delivery to a customer on the one hand and for the performance of tests during the development of software components on the other. A minimum quality status characterizes the quality status, i.e., the degree of successfully completed quality assurance measures that software components must have before they can be rolled out on vehicles in a fleet.

The formation of fleets with assigned attributes is based on the idea of dividing the entirety of vehicles that are technically suitable (i.e., due to their software-relevant equipment features) for the installation of a software component into disjoint subsets and organizing the roll-out of software components depending on the assignment of a vehicle to one of these subsets. The composition of fleets (i.e., the allocation of individual vehicles) can change dynamically, for example as a result of a sale or buyback or a technical change. The partitioning of the total quantity of vehicles in fleets can also be changed by new or modified software components and their grouping into software packages, which is described in more detail below.

At least one software package is formed, each comprising at least one software component in a version permanently assigned to the software package, wherein each software component is compatible with the at least one common equipment feature of at least one fleet. If the software package comprises a plurality of software components, these are also selected to be compatible with one another.

In particular, a software package is assigned those software-relevant equipment features required for the installation and operation of the software components included in the software package, for example a specific hardware platform for control units on which the installation of at least one of the software components of the software package is provided.

Each software package is also assigned a quality status that depends on the result of quality assurance measures performed on the software package. By way of example, a first quality status ‘new’ can be assigned when the first software component has been assigned to the software package. If the software package has been fully tested with all of its software components, the quality status ‘ready for delivery’ can be assigned. In between, depending on the progress of the quality assurance measures, further quality statuses can be assigned.

According to the invention, a software package is assigned to at least one fleet in each case based on the at least one common equipment feature of both the fleet and the software package and on the basis of the fleet type and/or the minimum quality status and/or the intended purpose of the respective fleet.

By way of example, software packages are only assigned to a fleet of ‘customer vehicles’ with the minimum quality status ‘ready for delivery’ and allocated for a download if they are compatible with the software-relevant equipment features of this fleet and also have the quality status ‘ready for delivery’.

This prevents software components with an insufficiently assured quality status from being rolled out in critical deployment environments.

Overall, the complexity of rolling out software components is also significantly reduced, as an allocation problem with a much smaller number of entities has to be solved compared to the current situation, in that mutually compatible software components are grouped together in software packages on the one hand and mutually equivalent vehicles are grouped together in fleets on the other.

In particular, automated roll-out of software components for testing purposes is possible. This enables agile software life cycles that allow faster and more efficient software development.

In addition, the method according to the invention allows the software distribution to be tracked. In particular, it is possible to log which fleets of vehicles have received which software packages in which quality status and when.

Furthermore, the grouping into fleets can be used to easily simulate the effects of the allocation of software packages to vehicles in advance before introducing or changing rules. This can prevent collisions during the distribution of software components.

Furthermore, the grouping in fleets and their description of an intended use allows the customized operation of customer groups. This means that packages of software functions can be customized for specific customer groups and rolled out with pinpoint accuracy.

In one embodiment, at least one first fleet with a fleet type provided for test purposes and at least one second fleet with a fleet type provided for delivery to and/or operation by a customer are formed for a set of vehicles with at least one common equipment feature. A different minimum quality status is assigned to the first fleet than to the second fleet, in such a way that a software package with a quality status provided for test purposes is assigned to the at least one vehicle of the first fleet, but not to the at least one vehicle of the second fleet.

With this embodiment, it is achieved that software components provided for test purposes are easily, in particular automatically, rolled out in test environments and that at the same time, vehicles in operational deployment environments, in particular such vehicles that are deployed for a customer or prepared for such deployment, are protected against the use of immature software components.

In one embodiment, the quality status assigned to a software package and a minimum quality status assigned to a fleet are taken from a list ordered according to the quality maturity level, which comprises the values ‘new’, ‘package formation completed’, ‘integration tests completed’, and ‘quality management tests completed’.

The value ‘new’ is assigned to a software package that is newly created, i.e. to which a first software component has been assigned.

The value ‘new’ is replaced by the value ‘package creation completed’ after all software components have been assigned.

The value ‘package creation completed’ is replaced by the value ‘integration tests completed’ after the quality assurance measures provided for the integration tests have been successful.

The value ‘integration tests completed’ is replaced by the value ‘quality management tests completed’ after all tests provided in the quality assurance measures have been successfully completed.

With this embodiment, software packages can be rolled out to fleets of vehicles in a particularly fine-grained and detailed yet automated manner. In particular, by extending the list of values for quality statuses, very specific test environments can be selected automatically and software packages can be rolled out there.

In one embodiment, when the quality status assigned to an original software package changes from the value ‘new’ to a different value (i.e., when a new value different from ‘new’ is assigned), a new version of this software package is generated and a quality status with the value ‘new’ is assigned to this new version, wherein the software components assigned to the original version of the software package are assigned to the new version of the software package. It is possible for the software components to be assigned to the new version of the software package in a different, preferably newer version than the original software package.

In this way, a software package can be continuously developed further without impairing stability in an operational operating environment, in particular in the vehicles used by or intended for a customer.

In one embodiment, a software package is generated (i.e., software components are assigned to it). The at least one common equipment feature required for this software package is then identified. At least one fleet is formed from the set of vehicles compatible with the software package (i.e., having the at least one common equipment feature). Preferably, a first and a second fleet are formed, wherein the fleet type and/or intended purpose of the first fleet is determined in accordance with an operational use and the fleet type and/or intended purpose of the second fleet is determined in accordance with a use for quality assurance, in particular for verification and/or testing.

One advantage of this embodiment is that the formation of fleets can be automated particularly well.

In one embodiment, when a software package is generated, it is checked whether the at least one required common equipment feature on which the software package is based conflicts with the at least one required common equipment feature of another software package. In particular, the creation of a software package is rejected if the software package to be created is based on a required equipment feature or set of required equipment features that is already based on or assigned to another (existing) software package.

This prevents several software packages from being assigned to one vehicle. This also avoids ambiguities in the assignment of software components of different versions to a vehicle.

According to a second aspect of the invention, a software distribution system for distributing at least one software component to at least one vehicle comprises a vehicle configuration database, an application management system, a software package management system, a fleet management system, and a package distribution component.

The vehicle configuration database is set up to assign equipment features to a vehicle. A vehicle can be uniquely identified by a number or character string known as a Vehicle Identification Number (VIN). According to its VIN, each vehicle in the vehicle configuration database can be assigned a set of equipment features, for example hardware platform, development status, system software, and/or other software components for each control unit of the vehicle.

The application management system is set up to manage software components with assigned versions, for example in the form of a software repository.

The software package management system is set up to record at least one software package comprising at least one software component in each case and to assign a quality status to the at least one software package.

The fleet management system is set up to assign a vehicle to a fleet and to assign at least one equipment feature and a minimum quality status and/or a fleet type and/or an intended purpose to a fleet.

The package distribution component is set up to assign a software package to the at least one vehicle of a fleet based on the at least one common equipment feature of both the fleet and the software package, based on the quality status of the software package, and based on the fleet type and/or the minimum quality status and/or the intended purpose of the respective fleet.

Optionally, the package distribution component is provided for a query from a vehicle, wherein the VIN of the querying vehicle is used to determine its assignment to a fleet, the software package assigned to this fleet is determined and transferred to the vehicle.

The advantages of the software distribution system according to the invention correspond to the advantages of the method according to the invention for distributing software components according to the first aspect of the invention.

In one embodiment, the application management system and/or the software package management system and/or the fleet management system and/or the package distribution component and/or the vehicle configuration database are designed as a backend system and are provided outside a vehicle. This makes it possible to provide a software distribution system with good availability that is particularly scalable.

Exemplary embodiments of the invention are explained in more detail below using drawings.

### BRIEF DESCRIPTION OF THE DRAWING FIGURES

Here are shown:

FIG. 1 schematically, a software distribution system according to the prior art, and

FIG. 2 schematically, a software distribution system comprising a package management system and a fleet management system.

Parts corresponding to one another are provided with the same reference numerals in all figures.

### DETAILED DESCRIPTION

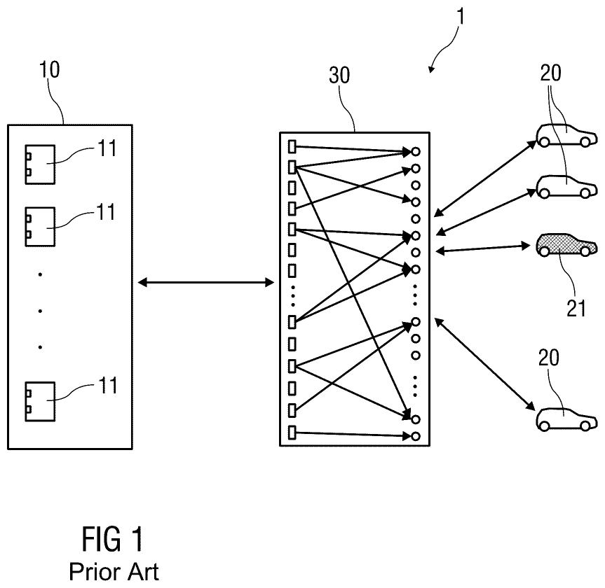

FIG. 1 schematically shows a software distribution system 1 according to the prior art, which is set up to distribute software components 11 to vehicles 20, 21. The software components 11 are managed and provided by a software repository 10.

The software components 11 can, for example, take the form of programs, applications, runtime libraries, configuration files, or multimedia data and are to be understood in the most general sense as resources which themselves run as a program on a control unit of a vehicle 20, 21 (not depicted in more detail in FIG. 1) or which are accessed at runtime from such a program. Such control units, for example infotainment devices known as head units, can be used in large numbers and in various design variants in vehicles 20, 21. Design variants can differ, for example, in the hardware configuration and/or in the software configuration. In addition, the same design variants of a control unit can also differ in terms of the version, i.e., the development status.

Vehicles 20, 21 of different vehicle types can be assigned the same software components, but can also be assigned different software components 11 depending on the vehicle type.

The vehicles 20, 21 can include vehicles of the same type, but also of different types, wherein vehicles of the same type can also have different equipment variants and versions. By way of example, two vehicles 20, 21 of the same vehicle type can have different hardware platforms, different hardware versions (i.e., different development statuses of a hardware platform), and/or different software versions for a certain control unit not depicted in more detail in FIG. 1.

In addition, a vehicle 20, 21 can have a plurality of applications or programs installed that rely on shared software components 11. When modifying such a shared software component 11, the compatibility with all of these applications or programs must then be taken into account.

The assignment of software components 11 to an individual first vehicle 21 thus requires consideration of the vehicle type, the equipment features, the developments statuses (version numbers) of the hardware and software already installed on the first vehicle 21 and consideration of all other software components 11 to be assigned to this first vehicle 21. It is possible that certain software components 11 are assigned both to the first vehicle 21 and to other vehicles 20, but other software components 11 are not.

Known methods solve this assignment problem with a central vehicle assignment component 30, which assigns software components 11 to a vehicle 20, 21 or a group of vehicles 20, 21. An individual vehicle 20, 21 can be identified by means of an identifier, for example by means of a character string referred to as a Vehicle Identification Number (VIN). In the event of a software update request, a vehicle 20, 21 can transmit such an identifier, based on which the central vehicle assignment component 30 determines the software components 11 assigned to the respective vehicle 20, 21 and transmits them to the vehicle 20, 21. However, due to the extraordinarily large number of vehicles 20, 21 and the large number of software components 11, which can also be designed differently for different hardware configurations and can also be available in different versions, such an assignment method is very complex.

To simplify matters, on the one hand, known vehicle assignment components 30 group vehicles 20, 21 into vehicle groups, for example into a group of test vehicles used for internal testing of software components 11 and into a group of customer vehicles. On the other hand, known vehicle assignment components 30 group software components 11 into packages. Such a package comprises a plurality of software components 11 and is usually assigned to one or more groups of vehicles 20, 21.

Accordingly, for example, new packages can be created for testing purposes and assigned to a certain group of vehicles 20, 21. While this procedure reduces the complexity of the assignment problem, there is a risk that packages comprising a certain number of software components 11, but without fixing their respective development statuses, are not rolled out to customer vehicles or are rolled out insufficiently tested.

By way of example, such a package can comprise three software components 11, which are simply labelled ‘A’, ‘B’ and ‘C’. The package is initially assigned to a group of test vehicles using the vehicle assignment component 30. After a successful test, the package is alternatively or additionally assigned to a group of customer vehicles. Subsequently, the software component 11 labelled ‘B’ is provided in a new version (a new development status).

This change takes effect immediately for all vehicles 20, 21 to which the package is assigned by means of the vehicle assignment component 30, and thus not only for the test vehicles but also for customer vehicles. This means that software components 11 that have not yet been tested or have only been incompletely tested can be installed on customer vehicles during the manufacturing process, but also during a software update. As a result, the reliability and operational safety of vehicles 20, 21 are impaired.

Furthermore, it is possible that by grouping vehicles 20, 21, a first vehicle 21 is assigned to several such groups, to each of which one or more packages with software components 11 are assigned. It is thus possible for several packages assigned to different groups to be considered for the first vehicle 21. As a result, software components 11 that are incompatible with each other can be unintentionally installed on the first vehicle 21. In addition, it is possible that the assignment of several such packages to a vehicle 21 can result in ambiguity if these packages comprise different versions of one and the same software component 11. The behavior of the software installed or updated on the vehicle 21 can then depend on the order of application of these packages and become unpredictable.

There is therefore a need for a method avoiding these disadvantages and with which software components 11 can be reliably, comprehensibly, and efficiently assigned to a plurality of vehicles 20, 21 and installed on them. In particular, there is a need for a method that can be automated and does not require the identification of an individual vehicle 20, 21.

FIG. 2 schematically shows a software distribution system 1 according to the invention, which comprises an application management system 100 (AMS), a software package management system 50 (SPM), a package distribution component 300, a fleet management system 40 (FM), and a vehicle configuration database 60 (VCD).

The software package management system 50 generates and manages software packages 51, each of which is assigned at least one, but typically a plurality of software components 11, each in a defined version. Furthermore, a software package 51 is assigned a quality status, for example an initial quality status ‘new’, a quality status ‘ready for testing’, or a quality status ‘ready for production’. A software package 51 is also assigned a version number. In addition, a software package 51 can be assigned a validity interval describing the period of time during which the software package 51 can be distributed to vehicles 20, 21 and/or operated there.

The software package management system 50 manages software packages 51 in such a way that components 11 are unalterably assigned to a software package 51. A component 11 assigned to the software package 51 with a certain version can only be exchanged for another version of the same software package 51 by assigning a new, incremented version to the software package 51 itself and also assigning an initial quality status ‘new’ again.

This ensures that the software components 11 comprised in a software package 51 and its version are uniquely and permanently defined. Unintentional changes to a software package 51, which could potentially compromise its quality, can thus be ruled out.

Preferably, the software package management system 50 is provided as a backend system on a server or as a cloud service outside a vehicle 20, 21.

The application management system 100 is set up for the recording, versioning, and provisioning software components 11. In particular, it is set up to permanently record different development statuses or versions and their predecessor-successor relationships (i.e., a tree of versions) for a software component 11, such that a development status can be identified and restored, for example by means of a hash value, a time stamp or a marker using a character string known as a ‘tag’.

The fleet management system 40 preferably assigns individual vehicles 20, 21 that can be identified by means of a VIN to one or optionally multiple fleets 41. A fleet 41 is formed by a plurality of vehicles 20, 21 that are equivalent at least in terms of their software-relevant equipment features, i.e., in terms of the ability to be installed and executability of software components 11, i.e., whose control units affected by these software components 11 have at least one identical hardware platform, for example.

The assignment of vehicles 20, 21 to fleets 41 is carried out automatically by the fleet management system 40 based on equipment features recorded in a vehicle configuration database 60 (VCD). Alternatively or additionally, vehicles 20, 21 can be manually assigned to one or more fleets 41.

Preferably, the fleet management system 40 generates a plurality of equivalent fleets 41 of the same, common fleet class for a set of software-relevant equipment features. The individual fleets 41 of a fleet class can differ in terms of a fleet type. By way of example, a fleet type can characterize a fleet 41 as being provided for test purposes. Alternatively, a fleet type can characterize a productively manufactured or deployed fleet 41 comprising vehicles 20, 21 used by a customer or potentially be sold to customers. A fleet type can also identify a fleet 41 provided for particular purposes, for example comprising vehicles 20, 21 provided for specific marketing events.

In one embodiment, the fleet management system 40 is provided as a backend system implemented on a server or as a cloud service outside a vehicle 20, 21.

Otherwise equivalent fleets 41 (described with the same software-relevant equipment features) can be treated differently depending on the fleet type in the software update, for example with regard to the required level of maturity or minimum quality status that a software component 11 must have in order to be assigned to a fleet 41 of a certain fleet type.

A fleet 41 can also be assigned a minimum required quality status, for example the quality status ‘ready for delivery’, irrespective of the assigned fleet type.

Furthermore, a fleet 41 can be assigned an intended purpose, for example the intended purpose ‘delivery’ or the intended purpose ‘internal tests’. This makes it possible to distribute software updates more specifically to fleets 41. By way of example, fleets 41 with the intended purpose ‘delivery’ can be excluded from software updates with software components 11 that still have to undergo component tests. On the other hand, software updates with software components 11 that have already been fully tested and for which user satisfaction surveys are to be conducted can be rolled out to fleets 41 with the intended purpose of ‘delivery’.

By grouping software components 11 into software packages 51 and by grouping vehicles 20, 21 (equivalent in terms of their compatibility with software packages 51) into fleets 41, the assignment of software components 11 to individual vehicles 20, 21 can be reduced compared to the prior art to the assignment of software packages 51 to fleets 41. This assignment is carried out by the package distribution component 300 based on the equipment features recorded in the vehicle configuration database 60. The reduced complexity of this assignment task compared to the previously known vehicle assignment component 30 is illustrated in FIG. 2 by the smaller vertical extent (corresponding to the smaller number of software packages 51 compared to the number of software components 11 and/or the smaller number of fleets 41 compared to the number of vehicles 20, 21). Preferably, the package distribution component 300 is provided as a backend system that is implemented outside the vehicle 20, 21 as a server or cloud service.

Furthermore, a quality assurance system (QAS) 70 is arranged between the software package management system 50 and the fleet management system 40. Depending on the results of the testing and/or other quality assurance measures with respect to the software components 11 of a software package 51, a quality status is determined by the quality assurance system 70. The determined quality status is assigned to a version of the software package 51 by the software package management system 50, which comprises a set of software components 11 in fixed, unchangeable versions.

The procedure for a software update on a first vehicle 21 with the software distribution system 1 is described below.

Prior to distribution, the first vehicle 21 makes a request to the package distribution component 300 for suitable software components 11. Based on the VIN transmitted with this request, the package distribution component 300 requests the assignment of the requesting first vehicle 21 to a fleet 41 from the fleet management system 40. The fleet management system 40 uses the VIN of the first vehicle 21 to determine its assigned fleet 41.

The package distribution component 300 then uses the assigned fleet 41 to determine a software package 51 provided for the first vehicle 21. In doing so, the package distribution component 300 takes into account the quality status of the software package 51 as well as its version and the fleet type, the intended purpose, and optional further attributes assigned to the fleet 41 according to a predetermined set of rules. By way of example, this can prevent a software package 51 in a version that is not assigned at least the quality status ‘ready for delivery’ from being delivered to a vehicle 21 that belongs to a fleet 41 with the intended purpose ‘delivery’ or with the fleet type ‘customer fleet’.

After the package distribution component 300 has determined the software package 51 provided for the first vehicle 21, it obtains this determined software package 51 from the software package management system 50. The software package management system 50, preferably configured as a backend system, returns a list of the software components 11 comprised by the requested software package 51 with their respective versions.

This list of software components 11 is returned by the package distribution component 300 to the first vehicle 21 in response to its request for suitable software components 11. Thereupon, the first vehicle 21 downloads the software components 11 in the list from the application management system 100 and installs them on the provided control unit or plurality of provided control units.

To create a software package 51, the software package management system 50 is provided with a description comprising a list of features of the vehicles 20, 21 for which the software package 51 is provided. Based on this description, the software package management system 50 checks the compatibility of the software package 51 with software packages 51 already recorded and/or distributed.

By way of example, the software package management system 50 rejects the request to create a software package 51 if another software package 51 has already been recorded and/or distributed for a set of features of vehicles 20, 21 identical to the transferred list, in order to avoid an assignment of multiple software packages 51 to one vehicle 20, 21.

Furthermore, the software package management system 50 can check the consistency of the features transferred in the list. By way of example, a comparison with the vehicle configuration database 60 can be used to check whether vehicles 20, 21 with the transferred combination of features, for example with a combination of a vehicle model with a hardware equipment variant of a control unit, are recorded there.

Furthermore, the software package management system 50 can check the uniqueness of the features transferred in the list. By way of example, an already recorded software package 51 could be assigned to a specific vehicle mode with a hardware equipment variant HW-A of a control unit. If the same vehicle model is combined with an engine type E-A as a feature in the list, the software package management system 50 checks whether vehicles 20, 21 of this vehicle model that have both the equipment variant HW-A of the control unit and the engine type E-A are recorded by comparing them with the vehicle configuration database 60. If such vehicles 20, 21 are recorded, the software package management system 50 divides the set of these vehicles 20, 21 into disjoint subsets. Alternatively, the software package management system 50 rejects the request to create a software package 51 based on the transferred list of features in order to prevent the assignment of different software packages 51 to these vehicles 20, 21.

The software package management system 50 also creates an initial version (‘version 0’) for a new software package 51 and assigns it the quality status ‘new’.

The software package management system 50 also initiates the creation of fleets 41 by the fleet management system 40. The fleet management system 40 first creates a fleet class, i.e., an abstraction of all possible fleets 41 that can be assigned the same software-relevant equipment features. Subsequently, the fleet management system 40 generates at least one, preferably several fleets 41 for such a fleet class, each of which comprises at least one vehicle 20, 21, preferably several vehicles 20, 21.

The fleet management system 40 stores the list of assigned equipment features for each of the fleet classes (e.g., comprising the vehicle model, the design variant, and optionally also the development status of a hardware platform for one or more control units and/or an engine type as well as other features). A software package 51 is also assigned to each fleet class and stored.

After the fleet class has been generated, the fleet management system 40 now generates at least one, preferably several, fleets 41 and assigns them to the fleet class. The fleets 41 of the same fleet class are assigned disjoint subsets of the set of vehicles 20, 21 having the equipment features that were assigned to the fleet class. This concerns current (i.e., already manufactured) and future manufactured vehicles 20, 21. However, the fleets 41 of the same fleet class can differ with regard to other attributes, for example with regard to the fleet type, the minimum quality status (required for installation of a software package 51 on vehicles 20, 21 of the respective fleet 41), and/or with regard to the intended purpose.

As already explained, a first fleet 41 of a fleet class can be characterized as a fleet 41 of test vehicles with which tests are carried out. A second fleet 41 of the same fleet class can be characterized as a marketing fleet. Vehicles 20, 21 of this fleet class are used for marketing events or roadshows. A third fleet 41 of the same fleet class can comprise, as a production fleet, those vehicles 20, 21 that are used by a customer or are provided for such use.

The fleets 41 are preferably formed automatically by the fleet management system 40 by first retrieving from the vehicle configuration database 60 the totality of the vehicles 20, 21 that have the equipment features that have been assigned to the respective fleet class. Vehicles 20, 21 are then selected from this totality and assigned to the fleet 41 which have the intended purpose assigned to the fleet 41 (either ‘delivery’ or ‘internal tests’) and optionally other features.

By dividing vehicles 20, 21 with software-relevant equivalent equipment features (i.e. set up for the installation of identical software packages 51) into disjoint fleets 41, the targeted execution of tests in specific deployment environments is made possible. At the same time, vehicles 20, 21 in critical deployment environments (typically those vehicles 20, 21 that have been assigned to a production fleet and/or whose intended purpose is ‘delivery’) are protected from the installation of software packages 51 that do not yet have a sufficient quality status for this deployment environment.

Newly developed or updated software components 11, i.e., provided in a new version, are recorded in the application management system 100. In addition to the software component 11 itself, its unique designation, its version and the list of equipment features of a vehicle 20, 21 that are required for installation are recorded and stored in this recording. These required equipment features can be assigned as attributes or labels.

The software package management system 50 then adds a new or a new version of a software component 11 to the software package 51,
to which the quality status ‘new’ is currently assigned and
to which the features of a vehicle 20, 21 identified as required for the newly provided software component 11 are assigned.

This ensures that new and not yet sufficiently tested software components 11 are not rolled out in critical operating environments with high quality requirements.

At predetermined intervals or on request, the software package management system 50 obtains confirmation from an approver to generate a new version of each software package 51 to which a new (or new version of a) software component 11 has been added. When the confirmation is given, the quality status of the software packages 51 concerned is set from ‘new’ to ‘creation completed’. A new version of the software package 51 is then generated for each software package 51 concerned, wherein each of the software components 11 comprised is transferred to the new version of the software package 51 and assigned the quality status ‘new’.

Software packages 51 provided with the quality status ‘creation completed’ are then verified by the quality assurance system 70. The quality assurance system 70 is informed of the change in the quality status from ‘new’ to ‘creation completed’ and then requests a fleet 41 suitable for the respective software package 51 from the fleet management system 40 for verification. The fleet management system 40 determines at least one suitable fleet 41 based on the features assigned to the software package 51 and/or on the basis of the assigned purpose and/or on the basis of the minimum quality status.

The verification can be automated, for example using formal verification tools, unit tests, or other automated test procedures. Alternatively or additionally, verification can also be carried out manually, for example by means of reviews or manual tests.

Only by way of example, smoke tests can be carried out to test the success of the distribution of the software package 51 to the control units of the vehicles 20, 21 assigned to the fleet 41. Additionally or alternatively, functional tests can be carried out. By way of example, it is possible to test whether a seat heating system is correctly controlled by the heating control function of the control unit equipped with the software package 51. Integration tests can also be carried out, such as the transmission of points of interest (POIs) from a smartphone to the navigation function of the control unit equipped with the software package 51 or checking the interaction between such a navigation function and a function for planning the vehicle battery charge of an electrically operated vehicle 20, 21.

Specific verification measures are determined according to the features of the respective software package 51, the assigned fleet 41 of test vehicles, the current quality status and/or the assigned version.

Once verification has been successfully completed, the respective software package 51 is assigned the quality status ‘ready for delivery’. Depending on the progress of the verification measures, further quality statuses can be assigned between the quality status ‘creation completed’ and the quality statuses ‘ready for delivery’, for example the quality status ‘completed service integration tests’ or the quality status ‘completed quality management tests’. These quality statuses represent increasing quality levels in the order mentioned.

Quality statuses are successively assigned depending on the success of the verification and/or quality assurance measures performed.

During its service life, a vehicle 20, 21 regularly requests the package distribution component 300 for the current list of software components 11 for the control unit or the control units, for example with each starting process, wherein the VIN of the vehicle 20, 21 is transferred.

The package distribution component 300 then determines the current software package 51 assigned to this vehicle 20, 21 as follows: based on the transferred VIN, the package distribution component 300 determines the features of the vehicle 20, 21 by querying the vehicle configuration database 60. Based on these features, the package distribution component 300 determines the fleet 41 assigned to the intended purpose of the vehicle 20, 21 and which has the greatest match to its features by querying the fleet management system 40.

The software package 51 determined in this way is obtained from the software package management system 50 in the latest (most recent) version whose validity interval comprises the time of the request and whose assigned quality status is equal to the minimum quality status assigned to the fleet 41 of the requesting vehicle 20, 21.

The software components 11 comprised by the software package 51 with this version are transferred to the requesting vehicle 20, 21 and installed on its control unit or control units.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-9. (canceled)

10. A method for distributing at least one software component to at least one vehicle, the method comprising:
forming a plurality of software packages, wherein each of the plurality of software packages comprises at least one software component in a version permanently assigned to a respective one of the plurality of software packages, wherein at least one fleet is formed from a totality of vehicles having at least one common equipment feature, wherein at least one minimum quality status, a fleet type, or an intended purpose are/is assigned to the at least one fleet, wherein each of the at least one software components is compatible with the at least one common equipment feature of the at least one fleet;
assigning each of the plurality of software packages a quality status depending on a result of quality assurance measures carried out on the respective one of the plurality of software packages;
assigning one of the plurality of software packages to the at least one fleet based on the at least one common equipment feature of both the at least one fleet and the respective one of the plurality of software packages, based on the quality status of the respective one of the plurality of software packages, and based on the fleet type, the minimum quality status, or the intended purpose of the respective fleet;
transferring the software package assigned to the at least one fleet to at least one vehicle in the at least one fleet; and
installing, by the at least one vehicle, the software components on at least one control unit of the at least one vehicle.

11. The method of claim 10, further comprising:
forming, from the at least one fleet for the totality of the vehicles, at least one first fleet with a fleet type provided for test purposes and at least one second fleet with a fleet type provided for delivery to or operation by a customer, wherein the totality of the vehicles include at least one common equipment feature; and
assigning the first fleet a different minimum quality state than the second fleet such that a software package with a quality status provided for test purposes is assigned to at least one vehicle of the first fleet, but is not assigned to at least one vehicle of the second fleet.

12. The method of claim 10, wherein the quality status assigned to a software package and a minimum quality status assigned to a fleet are obtained from an ordered list.

13. The method of claim 12, wherein the ordered list comprises the values ‘new’, ‘package formation completed’, ‘integration tests completed’, and ‘quality management tests completed’.

14. The method of claim 13, further comprising:
generating, when a quality status of an original software package is changed from the value ‘new’ to another value, a new version of the original software package and assigning the value ‘new’ to the new version of the original software package, wherein software components assigned to the original version of the software package are assigned to the new version of the original software package.

15. The method of claim 10, wherein the at least one software package is generated and then at least a first and a second fleet are formed to match the at least one common equipment feature of the at least one software package.

16. The method of claim 10, wherein during the generation of the at least one software package, the at least one equipment feature assigned to the at least one software package is determined and a generation is rejected if an existing software package is already assigned to the at least one equipment feature.

17. A software distribution system configured to distribute at least one software component to at least one vehicle, the software distribution system comprising:
a vehicle configuration database configured to assign equipment features to a vehicle;
an application management system configured to manage software components with assigned versions;
a software package management system configured to record at least one software package comprising at least one software component and to assign a quality status to the at least one software package;
a fleet management system configured to assign the at least one vehicle to a fleet and to assign at least one equipment feature, and a minimum quality status, as well as a fleet type or an intended purpose to a fleet; and
a package distribution component configured to assign the at least one software package to the at least one vehicle of the fleet based on the at least one common equipment feature of both the fleet and the at least one software package, the quality status of the at least one software package, and based on the fleet type, the minimum quality status, or the intended purpose of the respective fleet, wherein the package distribution component is further configured to transfer the at least one software package assigned to the fleet to the at least one, and
wherein the at least one vehicle is configured to install the software components on at least one control unit of the at least one vehicle.

18. The software distribution system of claim 17, wherein the application management system, the software package management system, the fleet management system, the package distribution component, or the vehicle configuration database is a backend system.
